(19) United States
(12) Patent Application Publication
(10) Pub. No.: US 2007/0119986 A1
(43) Pub. Date: May 31, 2007

(54) Surgical apparatus for separating a biological structure with the aid of a liquid jet

(76) Inventor: Konrad-Wenzel Winkler, Warin (DE)

Correspondence Address: WALTER OTTESEN, PO BOX 4026, GAITHERSBURG, MD, 20885-4026, US

(21) Appl. No.: 11/605,347

(22) Filed: Nov. 29, 2006

(30) Foreign Application Priority Data
Nov. 29, 2005 (DE) 20 2005 018 601.5

(51) Int. Cl. B05B 1/34

(52) U.S. Cl. 239/483

(57) ABSTRACT

A surgical apparatus has an HF-generator (16) which is connected via an electric line (17, 17′) to the suction tube (21, 21′) of the surgical handpiece (2) and to a large-area electrode. The surgical handpiece (2) is made of electrically conductive material and an electric contact surface (27) is configured at the distal end of the suction tube (21, 21′) and the electric contact surface (27) and the large-area electrode are designed to accommodate tissue parts therebetween.

### CROSS REFERENCE TO RELATED APPLICATION

This application claims priority of German patent application no. 20 2005 018 601.5, filed Nov. 29, 2005, the entire content of which is incorporated herein by reference.

### FIELD OF THE INVENTION

The invention relates to a surgical apparatus for separating a biological structure with the aid of a liquid jet. The surgical apparatus includes a supply pump for generating the jet of liquid, a vacuum pump for removing the separated tissue and the liquid introduced and a surgical handpiece having an injection cannula and a suction tube. The injection cannula has an injection nozzle and the suction tube has a suction opening. The injection nozzle and the suction opening are axially aligned and arranged at the distal end of the surgical handpiece. Apparatus of this kind are used in surgical clinics, especially for open surgery.

### BACKGROUND OF THE INVENTION

In medical practice, it has been established to separate biological structures with the force of a water jet in minimally invasive surgery as well as in open surgery. For this purpose, a water jet separating apparatus is used in each case which essentially includes the following: a pressure flow generator for building up a separating liquid jet, a vacuum pump for drawing off of liquids and separated tissue cells and a surgical handpiece. The surgical handpiece comprises an outer suction tube having one or several suction openings and an injection cannula, which is arranged within and coaxially to the suction tube, with the injection cannula having an injection nozzle disposed at its distal end. The configuration of the surgical handpiece is, in a special manner, matched to the most different applications.

United States patent application publication US 2004/0092987 A1 discloses a surgical handpiece for minimum invasive surgical procedures for removing fat tissue wherein the suction tube is closed at its distal end and is equipped only with a guide bore for passing the injection cannula therethrough. The suction openings, which are required for the suction, are radially aligned in multiple numbers and are distributed over the periphery of the suction tube. with this surgical handpiece, the fat tissue is separated in the forward region of the injection nozzle and drawn off by suction in the rearward region where the suction openings are located.

From the products provided by the company Human Med AG, 19061 Schwerin, Germany, a water jet separating apparatus is known under the name “Helix-Hydro-Jet” which uses a surgical handpiece for the minimally invasive surgery as well as for open surgery. This surgical handpiece has an outer suction tube which is open at its distal end and has an injection cannula aligned within and coaxially to the suction tube. In this way, a suction channel is provided which is annular in cross section and is disposed between the suction tube and the injection cannula. The suction channel likewise has an annular-shaped suction opening at the distal end of the suction tube and the suction opening is viewed in cross section. A spacer is disposed within the suction tube and this spacer aligns and fixes the injection cannula coaxially with respect to the suction tube.

When utilizing this surgical handpiece, special instruments are used for subsequent coagulation of the separated tissue parts and tubes which means that the surgeon must exchange the surgical instrument for a coagulation instrument. As a rule, high frequency electrical instruments are used and these HF-instruments can be configured to be monopolar as well as bipolar.

In the brochure of “Sutter Medizintechnik GmbH”, 79108 Freiburg, Germany, a plurality of bipolar tweezers were presented in 2004. Each pair of tweezers comprises two electrically conductive grip legs which are brought together to an electric plug coupling at the proximal end and which are spaced from one another with their leg tips at the distal end. With the exception of the coupling region and the leg tips, both grip legs are electrically insulated and hand grips and manipulating grips are configured on both grip legs in the region close to the coupling. With the leg tips of the bipolar tweezers, the open tissue is pressed together and is supplied with a high-frequency current whereby an electrical connection is short circuited between the two leg tips and via the clamped tissue and the tissue is coagulated under the influence of the generated heat.

According to page 26 of the brochure of Sutter Medizintechnik GmbH, this pair of tweezers is also available as bipolar flushing tweezers. For this purpose, a grip leg is configured to have a hollow shape and is configured with a proximal inlet connection for introducing a rinsing liquid and is configured with a distal outlet opening for the rinsing liquid. The distal outlet opening is aligned radially and is disposed on the inner side of the corresponding leg tip. In this way, the rinsing liquid is flushed during the coagulation and under a very slight distribution pressure onto the area of surgery in order to keep the surgical area clean and to prevent a drying out of the tissue.

On page 24 of the brochure of the Sutter Medizintechnik GmbH, a pair of bipolar suction tweezers is shown. In this pair of suction tweezers too, one leg is configured to have a hollow shape and is equipped with a distal suction opening at the leg tip and a proximal outlet connection. The distal suction opening is aligned axially. With this embodiment, blood, secretions and smoke are drawn off by suction before and during coagulation in order to always ensure a clear field of view during the surgical procedure.

Accordingly, for a surgical procedure, first the surgical instrument is needed for separating the biological structure, then the bipolar tweezers for rinsing and coagulation and then the bipolar tweezers for coagulation and removal by suction. In this way, the required apparatus technology is complex and expensive. The manipulation of the many instruments requires much time which unnecessarily lengthens the time for the surgical procedure and the patient is additionally burdened. In addition to the above, the quality of the surgical procedure suffers from the multiplicity of instruments because the many manipulations for changing the individual instruments lessens the concentration of the surgeon.

### SUMMARY OF THE INVENTION

It is an object of the invention to expand the functions of a surgical apparatus of the kind described above.

The surgical apparatus of the invention is for separating a biological structure with the aid of a liquid jet. The apparatus includes: a supply pump for generating a separating liquid jet; a vacuum pump for removing the separated tissue and the introduced liquid; a surgical handpiece including an injection cannula having an injection nozzle and a suction tube having a suction opening; the surgical handpiece having a distal end and the injection nozzle and the suction opening being mounted and axially aligned at the distal end; an HF-generator; a first electric line connecting the HF-generator to the suction tube; a second electric line connecting the HF-generator to an electrode; the surgical handpiece being made of electrically conducting material; the suction tube having a distal end whereat an electric contact surface is formed; and, the electrode and the electric contact surface being configured for accommodating tissue parts therebetween.

The surgical apparatus of the invention eliminates the above-mentioned disadvantages of the state of the art. A special advantage is that the simplest conditions are provided to the surgeon for the surgical procedure so that the surgeon can concentrate entirely on the surgical procedure.

The new surgical apparatus combines the known separation of tissue and suctioning off of separated tissue parts with the aid of a water jet with the subsequent coagulation with the rinsing of the location of incision in the tissue and the drawing off by suction of the flushing liquid. Previously, two units were required with the water supply unit and the HF-generator and three different surgical handpieces were needed with the surgical instrument of the water jet, the rinsing tweezers and the suction tweezers of the coagulation. The apparatus complexity is therefore considerably reduced. It is a further advantage that this apparatus is designed for monopolar operation as well as for bipolar operation. Notwithstanding the multiple functionality, the quality of the individual functions is maintained. In the bipolar configuration, it is an advantage when the suction tube and the injection cannula are configured to be coaxial and are accommodated in one of the two grip legs of the tweezers. This affords the advantage that the tweezers need not be continuously pressed together for separating and drawing off tissue by suction. On the other hand, it is advantageous when both grip legs of the tweezers are configured to be hollow and the suction tube is assigned to one grip leg and the injection cannula is assigned to the other grip leg. In this way, the outer diameters of the two grip legs can be minimized.

It is a special advantage, however, when the two grip legs of the tweezers cross over in the manner of a pair of scissors and therefore the actuating direction of the two grip legs is reversed. This saves the surgeon from continually pressing the tweezers together during the relatively long separating and suction operation.

### BRIEF DESCRIPTION OF THE DRAWINGS

The invention will now be described with reference to the drawings wherein:

FIG. 1 is a schematic of a surgical apparatus having a surgical handpiece in a monopolar embodiment;

FIG. 2 shows a side elevation view of the surgical handpiece in a bipolar embodiment;

FIG. 3 is a plan view of the surgical handpiece of FIG. 2;

FIG. 4 is a side elevation view of a surgical handpiece in another bipolar embodiment; and,

FIG. 5 is a plan view of the surgical handpiece of FIG. 4.

### DESCRIPTION OF THE PREFERRED EMBODIMENTS OF THE INVENTION

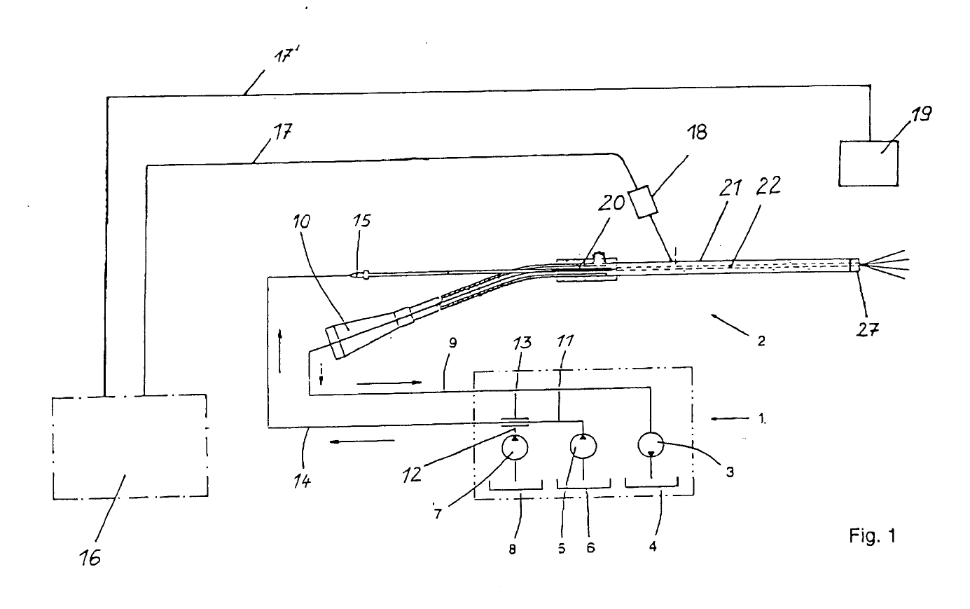

In FIG. 1, the surgical apparatus comprises a hydraulic supply unit 1 and a surgical handpiece 2. The supply unit 1 includes the following: a vacuum pump 3 having a take-up vessel 4; a hydraulic supply pump 5 having a supply vessel 6 for a sterile work liquid which can be formed into a jet; and, a hydraulic supply pump 7 having a supply vessel 8 for an anesthetic or another work liquid.

The vacuum pump 3 is connected via an underpressure line 9 to a coupling 10 of the surgical handpiece 2. In contrast, the two hydraulic supply pumps 5 and 7 have respective pressure lines 11 and 12 which both open into a switchable directional valve 13. This switchable directional valve 13 is provided for the use of the two supply pumps 5 and/or 7 and is, at the user end, connected to the surgical handpiece 2 via a pressure supply line 14 and a coupling 15.

The surgical apparatus further comprises an electric HF-generator 16 which can be operated monopolarly or bipolarly.

FIG. 1 shows a monopolar HF-current circuit wherein the HF-generator 16 is, on the one hand, connected to an electric coupling 18 of the surgical handpiece 2 via an active electric line 17 and, on the other hand, the HF-generator 16 leads to a contact electrode 19 via a neutral electric line 17′. This contact electrode 19 is designed to have a large area and is brought into contact with a body part of a patient.

The monopolar surgical handpiece 2 shown in FIG. 1 comprises a grip element 20 and a suction tube 21 fixedly attached thereto. An injection cannula 22 is disposed in this suction tube 21 and is coaxially aligned thereto. The inner diameter of the suction tube 21 and the outer diameter of the injection cannula 22 are so matched to each other that an annularly-shaped suction channel results having a cross section which is sufficient for the transport of tissue parts. The suction tube 21 is open at its distal end so that, at this location, an annularly-shaped suction opening is formed. The suction tube 21 is made of an electrically conductive material and is connected via the electric coupling 18 and the active line 17 to the HF-generator 16. The suction tube 21 is insulated over a large portion of its length and forms an active electrode at the distal end of the suction tube 21.

With the surgical apparatus and the monopolarly configured surgical handpiece 2, a biological structure is separated by the liquid jet exiting under pressure from the injection nozzle and the separated tissue parts together with the injected liquid are drawn off by suction via the suction tube 21. For the coagulation of the incision areas on the biological structure, the HF-generator 16 is activated whereby an electric current flows between the active contact electrode 19 applied to the patient, the neutral electrode on the suction tube 21 and through the human body. Because of the size ratios between the active contact electrode 19 and the neutral electrode at the suction tube 21, a greatest warming takes place at the region of the neutral electrode so that the tissue in this region becomes heated and is melted. The cut surfaces are thereby closed. A bipolar HF-current circuit is not shown in FIG. 1. This circuit differs from the monopolar current circuit shown in FIG. 1 only in that no contact electrode 19 is present and the active electric line 17 and the neutral electric line 17′ are guided together to the electric coupling 18 of the surgical handpiece 2.

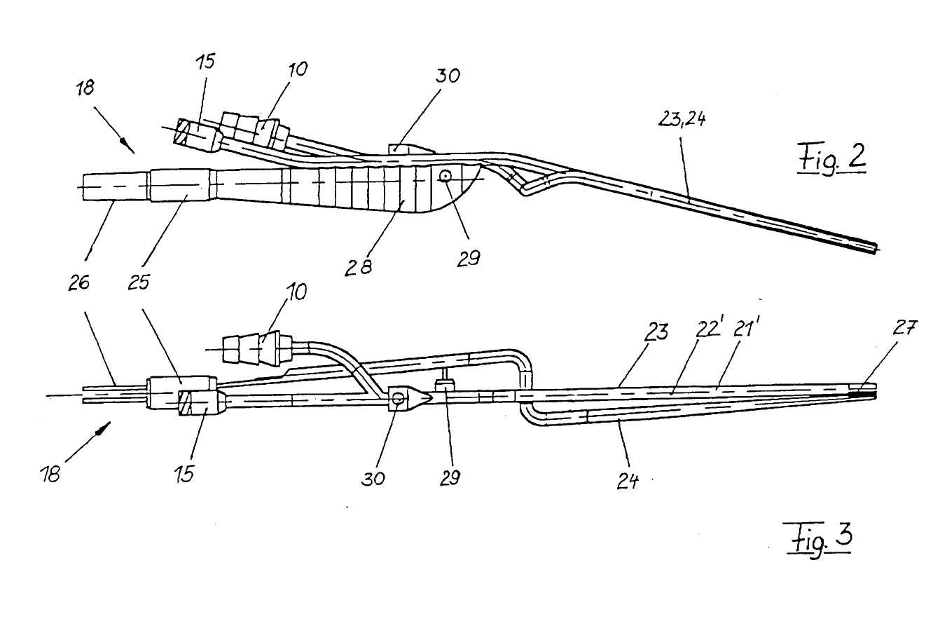

In FIGS. 2 to 5, the corresponding bipolar surgical handpiece 2 has the form of tweezers having two spring-biased supported grip legs (23, 24) which both are held together by a support piece 25 at the proximal end of the surgical handpiece 2 and are moved in opposition to the spring-biased pretensioning. This support piece 25 has electric contact elements 26 to provide a conductive connection between the two-pole electric line (17, 17′), which leads to the HF-generator 16, and each of the two grip legs (23, 24). One grip leg (23, 24) is configured as a neutral electrode and the other grip leg (23, 24) is configured as an active electrode and the two tips of the two grip legs (23, 24) are each provided with an electrically conductive contact surface 27 for the mutual contact. The tips of the two grip legs (23, 24) are arranged at the distal end. The remaining regions of the surgical handpiece 2 between the support piece 25 and the tips of the two grip legs (23, 24) are electrically insulated.

For ergonomic reasons, both grip legs (23, 24) have respective grip elements 28 in the proximate region of the support piece 25 and both grip legs (23, 24) are likewise angled over in elevation behind the two grip elements 28 for ergonomic reasons. At the inner sides of the two grip legs (23, 24), two opposite-lying centering elements 29 are located which mutually engage with reducing grip width of the two grip legs (23, 24) and which align both grip legs (23, 24) to each other in the pressed-together state and fix the same.

In a first embodiment of the bipolar surgical handpiece 2, one of the two grip legs (23, 24) of FIGS. 2 and 3 comprises an outer suction tube 21′ and an injection cannula 22′ arranged coaxially in the interior of the suction tube 21′. The inner diameter of the suction tube 21′ and the outer diameter of the injection cannula 22′ are so matched to each other that an annularly-shaped cross section results which is sufficient for the transport of liquid and tissue parts. At the distal end, the suction tube 21′ is configured to be open so that an annularly-shaped suction opening is formed at the end of the grip legs (23, 24). A holding element (not shown) is arranged in the interior of the suction tube 21′ and holds the injection cannula 22′ at a distance to the suction tube 21′. Behind the grip element 28, the inner injection cannula 22′ is guided out of the suction tube 21′ and is fixed together with the pressure supply line 14 via the coupling 15; whereas, the suction tube 21′ is connected to the coupling 10 leading to the underpressure line 9. In the region of the grip element 28, the suction tube 21′ of the one grip leg (23, 24) has a bypass suction opening 30 which can be closed by one finger of the surgeon for a suction operation and can again be opened for ending the suction operation.

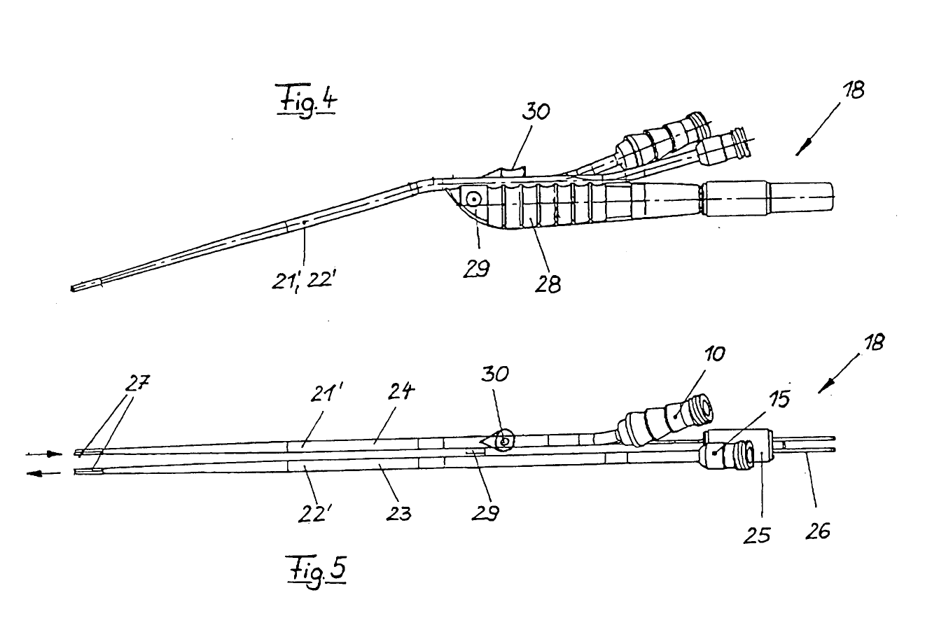

In a second embodiment of the bipolar surgical handpiece 2 according to FIGS. 4 and 5, both grip legs (23, 24) are configured to have a hollow shape. One grip leg (23, 24) is configured as a suction tube 21′ with a larger inner diameter and the other grip leg (23, 24) is configured as an injection cannula 22′ having a somewhat smaller inner diameter. At its distal end, the injection cannula 22′ has an axial discharge nozzle and, at its other end, is connected to the pressure supply line 14 via the coupling 15. At its distal end, the suction tube 21′ has an axial suction opening and an opposite-lying connection to the coupling 10 which leads to the underpressure line 9. The suction tube 21′ likewise has the bypass suction opening 30.

With this surgical apparatus and the two embodiments of a bipolarly-configured surgical handpiece 2 as coaxial or parallel suction and pressure line, a biological structure is separated by the liquid jet exiting under pressure from the injection nozzle and the separated tissue parts together with the injected liquid are drawn off by suction via the suction tube 21′. The two grip legs (23, 24) are pressed together continuously by the hand force of the surgeon so that the tips of both grip legs (23, 24) come into contact. For the coagulation of the cut areas on the biological structure, the tweezers are opened so that the two grip legs (23, 24) move apart. Thereafter, the tissue which is to be coagulated is grasped by the open tweezers and pressed together. At the same time, the HF-generator 16 is activated whereby an electric current flows between the two contact surfaces 27 and through the clamped tissue. The tissue heats up and melts.

FIG. 3 shows a special type of the tweezer form wherein both grip legs (23, 24) cross over in the manner of scissors on the length between the grip elements 28 and the tips of the two grip legs (23, 24). In this way, the two contact surfaces 27 of the tips of the two grip legs (23, 24) lie in contact with each other in the unloaded state of the tweezers. In contrast to the tweezers form described initially herein, the two grip legs (23, 24) are not pressed together by the manual force of the surgeon; rather, they are pressed apart and opened.

During the separation and suction, the two grip legs (23, 24) remain together exclusively by the spring-biased pretensioning. Thereafter, for coagulation of the cut surfaces, the tweezers are pressed together by the manual force of the surgeon for a short time and are thereby opened. The tissue is gripped with the open tweezers and then the manual force is again removed. Because of the force of the spring-biased pretensioning, the tweezers again close and press the tissue together. Thereafter, the HF-generator 16 is activated so that the tissue melts.

It is understood that the foregoing description is that of the preferred embodiments of the invention and that various changes and modifications may be made thereto without departing from the spirit and scope of the invention as defined in the appended claims.

What is claimed is:

1. A surgical apparatus for separating a biological structure with the aid of a liquid jet, the apparatus comprising:
a supply pump for generating a separating liquid jet;
a vacuum pump for removing the separated tissue and the introduced liquid;
a surgical handpiece including an injection cannula having an injection nozzle and a suction tube having a suction opening;
said surgical handpiece having a distal end and said injection nozzle and said suction opening being mounted and axially aligned at said distal end;
an HF-generator;
a first electric line connecting said HF-generator to said suction tube;
a second electric line connecting said HF-generator to an electrode;
said surgical handpiece being made of electrically conducting material;
said suction tube having a distal end where at an electric contact surface is formed; and,
said electrode and said electric contact surface being configured for accommodating tissue parts there between.

2. The surgical apparatus of claim 1, wherein said injection cannula is mounted within said suction tube and is aligned coaxially thereto; said surgical handpiece is configured for a monopolar coagulation; and, said electrode is configured as an external contact electrode for application to a body part of a patient.

3. The surgical apparatus of claim 1, wherein said surgical handpiece is configured for a bipolar coagulation; said surgical handpiece has the form of a pair of tweezers having first and second spring-biased grip legs; said grip legs are connected to corresponding ones of said first and second electric lines; said grip legs have respective tips defining respective inner sides; and, each of said inner sides defines an electric contact surface.

4. The surgical apparatus of claim 3, one of said grip legs being configured to have a hollow shape and including an outer suction tube and an inner injection cannula; and, said outer suction tube and said inner injection cannula being aligned coaxially with respect to each other.

5. The surgical apparatus of claim 3, wherein both of said grip legs are configured to have a hollow shape; and, one of said grip legs comprises said injection cannula and the other one of said grip legs comprises said suction tube.

6. The surgical apparatus of claim 4, wherein said grip legs cross over in the manner of a pair of scissors so that the two electric contact surfaces of said tips lie against each other when said pair of tweezers is in an unloaded state.

7. The surgical apparatus of claim 4, wherein said grip legs run parallel to each other and are so under tension that the two electric contact surfaces of said tips are spaced from each other by a predetermined amount in the unloaded state and a predetermined grip width adjusts between said tips.
